(19) United States
(12) Patent Application Publication
(10) Pub. No.: US 2007/0112154 A1
(43) Pub. Date: May 17, 2007

(54) Method for producing an (meth)acrylate syrup

(76) Inventors: Jae-gwan Lee, Daejeon (KR); No-ma Kim, Daejeon (KR); Suk-ky Chang, Daejeon (KR)

Correspondence Address: MCKENNA LONG & ALDRIDGE LLP, 1900 K STREET, NW, WASHINGTON, DC, 20006, US

(21) Appl. No.: 10/559,391

(22) PCT Filed: Sep. 8, 2005
(86) PCT No.: PCT/KR05/02973

§ 371 Date: Dec. 6, 2005

(30) Foreign Application Priority Data
Sep. 8, 2004 (KR) 102004 0071586

(51) Int. Cl. C08F 4/28

(52) U.S. Cl. 526/227; 526/319

(57) ABSTRACT

Disclosed is a method for producing (meth)acrylate syrup, the method comprising initiating polymerization using the following components at a temperature of 50-80° C.: a (meth)acrylate ester monomer, a chain transfer agent, a diacyl peroxide initiator, and 0.5-3.0 moles, based on 1 mole of the diacyl peroxide initiator, of a tertiary amine cocatalyst. In the disclosed method, a reaction runway does not occur even in bulk polymerization, it is easy to control molecular weight and it is possible to form a high-molecular weight (meth)acrylate syrup without stirring failure.

This application claims the benefit of the filing date of Korean Patent Application No. 10-2004-0071586, filed on Sep. 8, 2004 in the Korean Intellectual Property Office, the disclosure of which is incorporated herein in its entirety by reference.

### TECHNICAL FIELD

The present invention relates to a method for producing (meth)acrylate syrup. More particularly, the present invention relates to a method for producing (meth)acrylate syrup, in which reaction runaway does not occur even in bulk polymerization, it is easy to control molecular weight and it is possible to form a high-molecular weight (meth)acrylate syrup.

### BACKGROUND ART

In the prior art, (meth)acrylic resin compositions have been used in various applications, such as adhesive sheets, protective coating films and adhesives, because they have excellent transparency and it is easy to control the adhesion their cured material to various substrates. Although these materials for use in the respective applications became highly functional, the use of solution polymerization, emulsion polymerization or suspension polymerization for their production required much energy for the removal of residues. Also, in the use of this polymerization process, it was difficult to exhibit high function, and the load to environment was high. For these reasons, it is a tendency to produce (meth)acrylate by bulk polymerization or photopolymerization which is carried out in the absence of solvents.

The most difficult point in carrying out this bulk polymerization or photopolymerization is that, because a solvent to disperse exothermic heat is not used, the reactor temperature is difficult to control, resulting in a high possibility for reaction runaway.

In carrying out bulk polymerization in a general batch reactor, heat transfer is difficult due to the absence of solvent, and the termination of production of radicals is reduced due to a rapid increase in viscosity resulting from an increase in conversion rate. Thus, a phenomenon, such as the partial formation of gel, occurs, and non-uniform resin is liable to be obtained.

To overcome the problems of difficult heat transfer and viscosity increase, the use of a semi-batch, continuous or plug flow reactor in place of the batch reactor has been reported. Japanese patent laid-open publication Nos. Sho 40-003701, Hei 11-255828 and 2000-159816 disclose high-temperature polymerization with the use of this continuous polymerization method. However, the polymerization in this reactor has a problem in that it has a high economic burden, because not only the reactor itself is expensive but also the cost of utilities is significant. Another problem is that it is unfavorable for the production of large amounts of a few species, although it is suitable for the production of small amounts of many different species.

In an attempt to solve these problems, a method is known that carries out polymerization in the batch reactor under the mildest possible conditions. This is a method w here t he temperature of a reaction system is maintained at a constant level while forcibly terminating polymerization when the conversion or viscosity of the reaction system reaches a given level. Regarding t he method for the termination of polymerization, Japanese patent laid-open publication No. Hei 1-011652 discloses the termination of polymerization by the addition of a polymerization inhibitor, and Japanese patent laid-open publication No. Hei 9-067495 discloses polymerization termination, such as quenching by the addition of monomers. However, this polymerization method cannot become a fundamental solution because it has shortcomings in that it causes a great increase in viscosity at the latter half of reaction, shows a difference in physical properties depending on the time point of completion of reaction, and results in polymer syrup with poor storage stability because a polymerization inhibitor remains in the syrup.

In an attempt to solve these problems, there have been many solutions where a batch reactor is used but reaction runaway does not occur and the molecular weight of syrup is easily controlled.

First, there are examples where bulk polymerization was carried out without causing reaction runaway due to the non-use of a polymerization initiator. Japanese patent laid-open publication No. 2001-031709 discloses carrying out the bulk polymerization of a compound with a thiol group without a hydroxyl group or a compound with both a hydroxyl group and a thiol group in the substantial absence of an initiator. Also, Japanese patent laid-open publication No. 2001-302705 discloses carrying out the bulk polymerization of a compound with both a thiol group and a carboxyl group in the substantial absence of an initiator. However, these methods have a problem in that the polymerization needs to be conducted at relatively high temperature, because the reaction is made by the transfer of thermally generated radicals in the absence of the initiator so that the reaction rate is very slow. Another problem is that the polymerization efficiency is low.

Also, there is a case where an initiator with low half-life temperature is used. Japanese patent laid-open publication No. 2000-313704 discloses synthesizing an acrylate syrup with a conversion rate of 10-50%, in which 0.001-5.0 parts by weight of an polymerization initiator with a 10-hr half-life temperature of less than 41° C. is used, the self-heat generation at a reaction temperature of 20-80° C. is used, and the peak exothermic temperature of reactants reaches a range of 100-140° C. In this polymerization method, because the self-heat generation is used, the desired object can be achieved only if a very rapid increase in the concentration of radicals at the initial stage of reaction is made. It is considered that the very rapid increase in the concentration of radicals at the initial stage of reaction shows a rapid increase in conversion rate and the peak exothermic temperature, but after that, the reaction is stabilized and reaction runaway does not occur, because most of the initiator is already consumed. However, this method requires care since it is very difficult to handle and store initiators with low half-life temperature.

Meanwhile, when an initiator with relatively high half-life temperature is used alone in exothermic polymerization, it is needed to adjust initial reaction temperature to high temperature (10-hr half-life temperature of initiator+20° C.) in order to cause a rapid increase in the concentration of radicals at the initial stage of reaction. However, this high initial temperature of reaction has problems in that it leads to an increase in the peak exothermic reaction of a reaction system so as to increase a possibility for reaction runaway and to make the stable production of bulk syrup difficult.

### DISCLOSURE OF INVENTION

The present invention has been made to solve the above-described problems occurring in the prior art, and it is an object of the present invention to provide a method for producing (meth)acrylate syrup, in which reaction runaway does not occur even in bulk polymerization, it is easy to control molecular weight and it is possible to form a high-molecular weight (meth)acrylate syrup.

To achieve the above object, the present invention provides a method for producing (meth)acrylate syrup by bulk polymerization, the method comprising initiating polymerization using the following components at a temperature of 50-80° C.:

(a) 100 parts by weight of a (meth)acrylate ester monomer;

(b) 0.005-5 parts by weight of a chain transfer agent;

(c) 0.0001-1.0 part by weight of a diacyl peroxide initiator; and

(d) 0.5-3.0 moles, based on 1 mole of the component (c), of a tertiary amine cocatalyst.

The (meth)acrylate ester monomer used in the inventive method is not specifically limited and may be one generally used in the art. Examples of the (meth)acrylate ester monomer include a (meth)acrylate ester monomer with a C₁₋₁₂ alkyl group, and a polar (meth)acrylate ester monomer copolymerizable with said (meth)acrylate ester monomer. More specific examples of the (meth)acrylate ester monomer include methyl(meth)acrylate, ethyl(meth)acrylate, propyl(meth)acrylate, butyl(meth)acrylate, hexyl(meth)acrylate, isooctyl(meth)acrylate, 2-ethylhexyl(meth)acrylate, and isononyl(meth)acrylate.

Meanwhile, examples of the polar monomer copolymerizable with the (meth)acrylate ester monomer include carboxylic acid-containing monomers, such as (meth)acrylic acid, maleic acid, and fumaric acid, hydroxyl agoup-containing monomers, such as hydroxy(meth)acrylate, hydroxy(meth)methylacrylate, hydroxy(meth)ethylacrylate, hydroxy(meth)propylacrylate, and hydroxy(meth)butylacrylate, glycidyl group-containing monomers, such as glycidyl(meth)acrylate, and amine group-containing monomers, such as acrylamide.

These monomers may also be copolymerized with a third unsaturated monomer, such as styrene or benzoyl(meth)acrylate.

This polar monomer acts to impart cohesion to an adhesive and to improve adhesion.

Although the amount of use of the polar (meth)acrylate ester monomer copolymerizable with the (meth)acrylate ester monomer is specifically limited, it is generally 1-20 parts by weight based on 100 parts by weight of the (meth)acrylate ester monomer.

Examples of the diacyl peroxide initiator used in the inventive method include di-tert-butyl peroxide, dilauroyl peroxide, dibenzoyl peroxide, m-toluyl benzoyl peroxide, di(3,5,5-trimethylhexanoyl) peroxide, didecanoyl peroxide, and distearyl peroxide. Particularly preferred is dilauroyl peroxide or dibenzoyl peroxide.

The diacyl peroxide initiators may be used alone or in a mixture of two or more thereof. The diacyl peroxide initiator is used in an amount of 0.0001-1.0 parts by weight, preferably 0.001-0.1 parts by weight, and more preferably 0.004-0.05 parts by weight, based on 100 parts by weight of the (meth)acrylate ester monomer. If the diacyl peroxide initiator is used in an amount of less than 0.0001 part by weight, the initiation efficiency of polymerization will be reduced and a phenomenon will occur where reaction continues to progress, and if it is used in amount of more than 1.0 part by weight, it will be difficult to control the temperature within a polymerization reactor.

Examples of the tertiary amine cocatalyst used in the inventive method include N,N′-dimethyl aniline, N,N′-dimethyl-p-toluidine, N,N′-dihydroxyethyl-p-toluidine, N,N′-dihydroxypropyl-p-toluidine, 4-dimethylamino)phenethyl alcohol, and 4-(dimethylamino)phenyl alcohol.

The tertiary amine cocatalysts may be used alone or in a mixture of two or mote thereof. The tertiary amine cocatalyst is used in an amount of 0.5-3 moles based on 1 mole of the diacyl peroxide initiator. If the tertiary amine cocatalyst is used in an amount of less than 0.5 moles, it will be difficult for the organic peroxide to initiate polymerization sufficiently, and if it is used in an amount of more than 3.0 moles, it will remain in a final product, resulting in deterioration in the product quality.

The chain transfer agent used in the inventive method is not specifically limited if it is an organic compound with a thiol group (—SH). Examples of the chain transfer agent include alkyl mercaptans, such as ethyl mercaptan, butyl mercaptan, hexyl mercaptan, and dodecyl mercaptan, thiophenols, such as phenyl mercaptan and benzyl mercaptan, carboxyl group-containing mercaptans, such as thioglycolic acid, 3-mercapto propionic acid, and thiosalicylic acid, hydroxyl group-containing mercaptans, such as 2-mercapto ethanol, and 3-mercapto-1,2-propanediol, and mercaptans with a combination of two or more of the above-described functional groups, such as pentaerythritol tertrakis(3-mercapto)propionate.

The chain transfer agent is used in an amount of 0.005-5 parts by weight based on 100 parts by weight of the (meth)acrylate ester monomer. If the amount of use of the chain transfer agent is less than 0.005 parts by weight, polymerization will rapidly progress and at the same time, uniform mixing within a reactor will not be made, and the molecular weight of the resulting polymer will excessively increase. If it is more than 5 parts by weight, polymerization rate will become slow and molecular weight will be excessively reduced, resulting in deterioration in the physical properties of a final product.

In the inventive method, a polymerization inhibitor may also be used. The polymerization inhibitor is not specifically limited if it is a compound capable of absorbing radicals to terminate radical reaction, for example, hydroquinone, or 4-methoxyphenol.

The reaction temperature in the inventive method is preferably as low as possible, insofar as it does not interfere with the smooth production of radicals by the diacyl peroxide and the tertiary amine cocatalyst. The reaction temperature meeting this condition is 50-80° C., and preferably 60˜75° C. If the reaction temperature is less than 50° C., reaction rate will become excessively low or the formation of radicals will become difficult, and if it is more than 80° C., reaction rate will excessively increase, resulting in an excessive increase in the peak exothermic temperature, leading to a high possibility for reaction runaway.

After the initiation of reaction, the self-heat generation of the reaction system by the consumption of the initiator occurs, and the peak exothermic temperature of the reaction system reaches a range of 100-160° C. and preferably 120-140° C. If the temperature of the reaction system exceeds 160° C., a possibility for reaction runaway resulting from the production of radicals by heat will naturally increase, and if it is less than 100° C., reaction will continue to progress with time even following the peak exothermic temperature, thus making it impossible to control the reaction. Although special warming and cooling are not required since the temperature of the reaction system following the peak exothermic temperature gradually naturally decreases, warming and cooling may also be carried out, if necessary.

Also, the time taken to reach the peak exothermic temperature is preferably shorter than 20 minutes. If the time taken to reach the peak exothermic temperature is longer than 20 minutes, it can be considered as the relatively slow progression of reaction. This slow progression of reaction makes the consumption rate of the initiator slow, so that heat generation continues to progress even following the peak exothermic temperature, polymerization rate constantly increases, and viscosity excessively increases, thus making the control of the reaction system difficult.

The (meth)acrylate syrup produced by the inventive method is in the form of a partially polymerized acrylate syrup with a conversion rate of 10-70%, and may be diluted with a new monomer, if necessary after the reaction.

The physical properties of the (meth)acrylate syrup synthesized by the inventive method are evaluated in the following manner.

1. Measurement of solid concentration

The concentration of solids in the syrup is measured by dropping about 0.1-1.3 g of the syrup onto apreviously weighed aluminum dish, measuring the weight of the resulting dish, drying the syrup in an oven at 130° C. for 1 hour, and then, measuring the weight of the dried dish.

2. Measurement of viscosity

The viscosity of the syrup is measured with a Brookfield viscometer.

3. Measurement of molecular weight

The molecular weight of the syrup is measured in a multi-angle laser light scattering (GPC-Malls) detector (Waytt DAWN EOS) using tetrahydrofuran (THF) solvent at 0.8 mL/min.

### BEST MODE FOR CARRYING OUT THE INVENTION

Hereinafter, preferred examples will be presented for a better understanding of the present invention. It is to be understood, however, that theses examples are given for illustrative purpose only and are not construed to limit the scope of the present invention.

### EXAMPLE 1

Into a 1-liter four-necked glass reactor equipped with a nitrogen gas inlet tube, a temperature sensor and a condenser, 570 g of 2-ethyl hexyl acrylate (2-EHA), 30 g of acrylic acid (AA) and 0.24 g of dodecyl mercaptan (n-DDM), a chain transfer agent, were charged. The mixture was heated to a reaction temperature of 70° C. while removing dissolved oxygen with nitrogen stream for 30 minutes. Then, 0.025 g of 4-(dimethylamino)penethyl alcohol (DMAPA), as a tertiary amine cocatalyst, was added to the mixture and thoroughly mixed, to which 0.036 g of dibenzoyl peroxide (BPO), a diacyl peroxide initiator, was added to initiate reaction.

Temperature in the reaction was elevated to a peak exothermic temperature of 125° C. only within 8 minutes, and after 30 minutes, lowered to the reaction temperature set prior to the initiation of the reaction. After that, an increase in the viscosity of the reaction solution did not occur and the phenomena of heat generation and reaction runaway also did not appear.

After one hour, 285 g of 2-ethyl hexyl acrylate with room temperature and 15 g of acrylic acid were added for cooling, and 0.035 g of hydroquinone, a polymerization inhibitor, was added to terminate the reaction.

The concentration of solids in the partially polymerized syrup thus obtained was 49.9%, and the syrup had a viscosity of 10,800 centipoise (cP) and a molecular weight of 350,000.

### EXAMPLE 2

Into the reactor as described in Example, 570 g of butyl acrylate (BA), 30 g of acrylic acid (AA) and 0.24 g of dodecyl mercaptan (n-DDM) were charged. Reaction was carried out in the same manner as in Example 1 except that the reaction temperature was 60° C., 0.06 g of a dilauroyl peroxide (LPO) initiator was used, and 285 of butyl acrylate with room temperature and 15 g of acrylic acid were added for cooling.

Temperature in the reaction was elevated to a peak exothermic temperature of 120° C. only within 6 minutes, and after 30 minutes, lowered to the reaction temperature set prior to the initiation of reaction. After that, an increase in the viscosity of the reaction solution did not occur and the phenomena of heat generation and reaction runaway also did not appear. The concentration of solids in the partially polymerized syrup thus obtained was 50.4%, and the syrup had a viscosity of 11,000 centipoise (cP) and a molecular weight of 350,000.

### EXAMPLE 3

Into the reactor as described in Example 1, the same monomers as in Example 1 were charged in the same amounts as in Example 1. Reaction was carried out in the same manner as in Example except that 0.58 g of pentaerythritol tetrakis(3-mercapto)propionate as a chain transfer agent, 0.036 g of dibenzoyl peroxide initiator and 0.020 g of N,N′-dimethyl-p-toluidine (DMT) as a tertiary a mine c ocatalyst were used.

Temperature in the reaction was elevated to a peak exothermic temperature of 122° C. only within 8 minutes, and after 30 minutes, lowered to the reaction temperature set prior to the initiation of reaction. After that, an increase in the viscosity of the reaction solution did not occur and the phenomena of heat generation and reaction runaway also did not appear. The concentration of solids in the partially polymerized syrup thus obtained was 47.8%, and the syrup had a viscosity of 7,700 centipoise (cP) and a molecular weight of 330,000.

### EXAMPLE 4

Reaction was carried out in the same manner as in Example 1 except that 600 g of 2-ethyl hexyl acrylate (2-EHA) was charged alone into the reactor as described in Example 1, without using acrylic acid (AA).

Temperature in the reaction was elevated to a peak exothermic temperature of 126° C. only within 8 minutes, and after 30 minutes, lowered to the reaction temperature set prior to the initiation of reaction. After that, an increase in the viscosity of the reaction solution did not occur and the phenomena of heat generation and reaction runaway also did not appear. The concentration of solids in the partially polymerized syrup thus obtained was 47.2%, and the syrup had a viscosity of 8,000 centipoise (cP) and a molecular weight of 360,000.

### COMPARATIVE EXAMPLE 1

Reaction was carried out in the same manner as in Example 1 except that the tertiary amine cocatalyst was not used. Temperature in the reaction reached a very low peak exothermic temperature of 76° C. after 10 minutes. Then, the reaction continued to progress so that an increase in viscosity continuously occurred, thus making stirring impossible. For this reason, the reaction was forcibly terminated.

### COMPARATIVE EXAMPLE 2

Reaction was performed in the same manner as in Example 1 except that 4-(dimethylamino)penethyl alcohol (DMAPA) as a tertiary amine cocatalyst was used in an amount of 0.4 moles (0.010 g) based on 1 mole of dibenzoyl peroxide as an initiator. Temperature in the reaction reached a low peak exothermic temperature of 95° C. after 20 minutes. Then, the reaction continued to progress so that an increase in viscosity continuously occurred, thus making stirring impossible. For this reason, the reaction was forcibly terminated.

### COMPARATIVE EXAMPLE 3

Reaction was carried out in the same m anner as in Example 1 except that 4-(dimethylamino)penethyl alcohol (DMAPA) as a tertiary amine cocatalyst was used in an amount of 3.5 moles (0.088 g) based on dibenzoyl peroxide as an initiator. The reaction progressed very slowly and showed yellowing by an excess of the amine.

### EXAMPLE 4

Reaction was carried out in the same manner as in Example 1 except that the reaction temperature was changed to 90° C. Temperature in the reaction reached 170° C. within 4 minutes, and heat generation continued to progress without a reduction in the reaction temperature. Also, the reaction solution showed fog by the volatilization of the monomers and become impossible to stir. For this reason, the reaction was forcibly terminated.

### COMPARATIVE EXAMPLE 5

Reaction was carried out in the same manner as in Example 1 except that the chain transfer agent was not used. Temperature in the reaction reached 170° C. within 8 minutes and then, within 30 minutes, lowered to the reaction temperature prior to the initiation of reaction. However, the viscosity of the reaction solution was excessively increased to make stirring impossible. For this reason, the reaction was forcibly terminated.

### INDUSTRIAL APPLICABILITY

As described above, in the inventive method for producing (meth)acrylate syrup, a runway reaction does not occur even in bulk polymerization, it is easy to control molecular weight and it is possible to form a high-molecular weight (meth)acrylate syrup without stirring failure.

The inventive method for producing (meth)acrylate syrup uses the exothermic heat of a reaction system after the initiation of polymerization, so that the peak exothermic temperature of the reaction system is reached within a short time together with the rapid degradation of the initiator and the termination of the reaction within a short time, and after that, the reaction no longer progresses. Thus, according to the inventive method, it is possible to stably produce a partially polymerized (meth)acrylate syrup.

What is claimed is:

1. A method for producing (meth)acrylate syrup by bulk polymerization, the method comprising initiating polymerization using the following components at a temperature of 50-80° C.:
(a) 100 parts by weight of a (meth)acrylate ester monomer;
(b) 0.005-5 parts by weight of a chain transfer agent;
(c) 0.0001-1.0 part by weight of a diacyl peroxide initiator; and
(d) 0.5-3.0 moles, based on 1 mole of the component (c), of a tertiary amine cocatalyst.

2. The method of claim 1, wherein the diacyl peroxide initiator is at least one selected from the group consisting of di-tert-butyl peroxide, dilauroyl peroxide, dibenzoyl peroxide, m-toluyl benzoyl peroxide, di(3,5,5-trimethylhexanoyl) peroxide, didecanoyl peroxide, and distearyl peroxide.

3. The method of claim 1, wherein the tertiary amine cocatalyst is at least one aromatic tertiary amine compound selected from the group consisting of N,N′-dimethyl aniline, N, N′-dimethyl-p-toluidine, N,N′-dihydroxyethyl-p-toluidine, N,N′-dihydroxypropyl-p-toluidine, 4-dimethylamino)phenethyl alcohol, and 4-(dimethylamino)phenyl alcohol.

4. The method of claim 1, wherein the reaction system reaches a peak exothermic temperature of 100-160° C. within the initiation of the polymerization.

5. The method of claim 1, wherein the syrup is a partially polymerized (meth)acrylate syrup with a conversion rate of 10-70%.
